(19) United States
(12) Patent Application Publication
(10) Pub. No.: US 2009/0080125 A1
(43) Pub. Date: Mar. 26, 2009

(54) MAGNETIC HEAD

(75) Inventor: Reiko Kondo, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/326,546

(22) Filed: Dec. 2, 2008

Related U.S. Application Data
(63) Continuation of application No. PCT/JP2007/000265, filed on Mar. 20, 2007.

(51) Int. Cl. G11B 5/127

(52) U.S. Cl. 360/324.12

(57) ABSTRACT

A magnetic head is configured to include a free layer having a magnetization direction which is rotatable depending on an external field, a reference layer arranged parallel to the free layer and magnetically isolated from the free layer, and a pinned layer arranged parallel to the reference layer. The pinned layer and the reference layer are antiferromagnetically coupled. The pinned layer has a magnetization direction which is pinned in a predetermined direction, and a magnetization direction of the reference layer is antiparallel with respect to that of the pinned layer. The pinned layer is configured to have an area larger than that of the reference layer.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2007/000265 filed Mar. 20, 2007, in the Japanese Patent Office, the disclosure of which is hereby incorporated by reference.

### BACKGROUND OF THE INVENTION

1. Field of the Invention

The present invention generally relates to magnetic heads, and more particularly to a magnetic head which includes a spin-valve magneto-resistance device as a reproducing (or read) head.

2. Description of the Related Art

A write head of the magnetic head is normally formed by an inductive type magnetic head. The inductive type magnetic head may also be used as a reproducing head. In this case, the physical quantity detected by the magnetic head becomes a change in the magnetic flux density with time, which depends upon a relative velocity between a magnetic recording medium and the magnetic head.

Magneto-Resistance (MR) is the phenomenon in which the electrical resistance changes depending on the external field. The Anisotropic Magneto-Resistance (AMR) is the phenomenon in which the electrical resistance changes depending on the direction and the intensity of the external field. When an AMR device, which uses the AMR effect, is used as the reproducing head, the reproduced output from the reproducing head no longer becomes dependent on the relative velocity between the magnetic recording medium and the magnetic head. Hence, it becomes difficult to form a magnetic head which is suited for reducing the size of the magnetic storage apparatus and for realizing a high recording density.

The prior art described in a Japanese Patent No. 2786601 includes the reproducing head using the Giant Magneto-Resistance (GMR) effect. The GMR device has two ferromagnetic layers which are separated by a nonmagnetic metal layer, and one of the ferromagnetic layers is referred to as a pinned layer with pinned magnetization, while the other is referred to as free layer in which the magnetization orientation is free. In such a spin valve MR sensor, the magnetization of the pinned layer should be oriented perpendicular to the disk surface, while the magnetization of the free layer should be oriented parallel to the disk surface. However, the magnetization direction of the free layer is affected by the magnetic field generated by the pinned layer.

A Japanese Laid-Open Patent Application No. 2004-335071 proposes a Current Perpendicular to the plane (CPP) structure in which the spin valve MR sensor is interposed between a pair of shield layers and a current is made to flow between the shield layers, and wherein the spin valve MR device is electrically connected to the shield layers via the nonmagnetic metal layer having a larger area.

A Japanese Laid-Open Patent Application No. 2004-118978 proposes a CPP type spin valve MR device in which the height of the pinned layer in the opposing direction in which the CPP type spin valve MR device opposes the magnetic recording medium is set higher than the height of the free layer in the opposing direction, in order to suppress inclination of the magnetization direction of the pinned layer due to external disturbances.

A Japanese Laid-Open Patent Application No. 2005-302846 proposes a spin valve having an antiferromagnetic layer, a pinned layer, a nonmagnetic layer and a free layer which are stacked, and wherein the heights of the antiferromagnetic layer and the pinned layer are set higher than the height of the free layer in order to reduce the leak magnetic field applied from the pinned layer to the free layer.

The Japanese Patent No. 2786601 proposes forming the pinned layer of the spin valve MR sensor by a pair of Ni—Fe ferromagnetic layers which are coupled via an antiferromagnetically coupling layer which is 0.3 nm to 0.6 nm thick and is made of Ru, and an antiferromagnetic layer which pins the magnetization direction of one of the pair of ferromagnetic layers. By making the two ferromagnetic layers which are magnetized in antiparallel magnetization directions to approximately the same thickness, the two magnetic moments essentially cancel each other, and it is possible to basically eliminate the dipole field which causes undesirable effects on the free layer.

This proposed structure is referred to as a laminated ferri structure, and the layer having the magnetization direction pinned by antiferromagnetic layer is referred to as a pinned layer, while the layer which is anti-ferromagnetically coupled to the pinned layer is referred to as a reference layer.

FIG. 1 is a perspective view illustrating the laminated ferri structure of the MR sensor of the type proposed in the Japanese Patent No. 2786601, for example. The laminated ferri structure illustrated in FIG. 1 includes a pinned layer 300, a reference layer 500 and a free layer 700 which are successively stacked. The magnetization direction of the pinned layer 300 is pinned in a direction taken along a device height MRh (hereinafter simply referred to as a device height direction MRh). The magnetization direction of the reference layer 500 is antiparallel with respect to that of the pinned layer 300. The magnetization direction of the free layer 700 is set in a direction taken along a core width CW (hereinafter simply referred to as a core width direction CW) in a state where no external field is applied, and can freely be rotated by the applied external field. The parallel layers 300, 500 and 700 are patterned to the same shape, along both the device height direction MRh and the core width direction CW. The core width direction CW corresponds to a direction taken along a track width (track width direction) on the magnetic recording medium.

A Japanese Laid-Open Patent Application No. 2006-13430 proposes a MR sensor having the laminated ferri structure, in which the product of the thickness and saturation magnetic flux intensity of the pinned layer is set larger than the product of the thickness and saturation magnetic flux density of the reference layer, in order to mutually cancel the effects of the reference layer and the pinned layer on the free layer.

### SUMMARY OF THE INVENTION

Accordingly, it is a general object of the present invention to provide a novel and useful magnetic head in which the problems described above are suppressed.

One object of the present invention is to provide a spin valve MR device having the laminated ferri structure, in which the undesirable effects of the magnetizations of the pinned layer and the reference layer on the magnetization of the free layer are reduced.

Another object of the present invention is to provide a magnetic head which includes a spin valve MR device having a laminated ferri structure with an improved performance.

According to one aspect of the present invention, there is provided a magnetic head comprising a free layer made of a ferromagnetic material and having a magnetization direction which is rotatable depending on an external field, a reference layer made of a ferromagnetic material and arranged parallel to the free layer, where the reference layer is magnetically isolated from the free layer, and a pinned layer made of a ferromagnetic material and arranged parallel to the reference layer, wherein the pinned layer and the reference layer are antiferromagnetically coupled, the pinned layer has a magnetization direction which is pinned in a first direction, a magnetization direction of the reference layer is antiparallel with respect to that of the pinned layer, and the pinned layer has an area larger than that of the reference layer.

According to another aspect of the present invention, there is provided a magnetic storage apparatus comprising a magnetic recording medium having a rotating surface, and a magnetic head arranged to confront the rotating surface of the magnetic recording medium, where the magnetic head comprises a free layer made of a ferromagnetic material and having a magnetization direction which is rotatable depending on an external field, a reference layer made of a ferromagnetic material and arranged parallel to the free layer, where the reference layer is magnetically isolated from the free layer, and a pinned layer made of a ferromagnetic material and arranged parallel to the reference layer, wherein the pinned layer and the reference layer are antiferromagnetically coupled, the pinned layer has a magnetization direction which is pinned in a first direction, a magnetization direction of the reference layer is antiparallel with respect to that of the pinned layer, and the pinned layer has an area larger than that of the reference layer.

Other objects and further features of the present invention will be apparent from the following detailed description when read in conjunction with the accompanying drawings.

### BRIEF DESCRIPTION OF THE DRAWINGS

FIG. 1 is a perspective view generally illustrating a laminated ferri structure of a MR sensor;

FIG. 2 is a perspective view generally illustrating a laminated ferri structure in an embodiment of the present invention;

FIG. 3 is a cross sectional view illustrating the laminated ferri structure of FIG. 2 sandwiched between a pair of shield layers;

FIG. 4 is a graph illustrating simulation results of a combined leak magnetic field which is made up of a leak magnetic field from a reference layer and a leak magnetic field from a pinned layer;

FIG. 5 is a plan view generally illustrating the structure of the hard disk magnetic recoding apparatus;

FIG. 6 is a cross sectional view generally illustrating the structure of a write and read head;

FIG. 7 is a perspective view illustrating the laminated ferri structure of a spin valve magnetic read device;

FIGS. 8A through 8F are cross sectional views, taken along a core width direction, illustrating the laminated ferri structure at typical fabricating stages in a method of fabricating the laminated ferri structure;

FIGS. 9A through 9F are cross sectional views, taken along a device height direction, illustrating the laminated ferri structure at the typical fabricating stages in the method of fabricating the laminated ferri structure;

FIG. 10 is a perspective view generally illustrating a laminated ferri structure in a first modification of the embodiment of the present invention;

FIG. 11 is a cross sectional view illustrating the laminated ferri structure of FIG. 10 sandwiched between a pair of shield layers;

FIG. 12 is a graph illustrating simulation results of the combined leak magnetic field which is made up of the leak magnetic field from the reference layer and the leak magnetic field from the pinned layer;

FIG. 13 is a perspective view illustrating the laminated ferri structure of a spin valve magnetic read device;

FIGS. 14A and 14B are cross sectional views, taken along a core width direction, illustrating the laminated ferri structure at typical fabricating stages in a method of fabricating the laminated ferri structure;

FIGS. 15A and 15B are cross sectional views, taken along a device height direction, illustrating the laminated ferri structure at the typical fabricating stages in the method of fabricating the laminated ferri structure;

FIG. 16 is a perspective view illustrating the laminated ferri structure of a spin valve magnetic read device in a second modification; and

FIG. 17 is a cross sectional view illustrating the laminated ferri structure of FIG. 16 in more detail.

### DESCRIPTION OF THE PREFERRED EMBODIMENTS

First, a description will be given of the findings made by the present inventor, in relation to the MR sensor or, the GMR type reproducing head, having the laminated ferri structure.

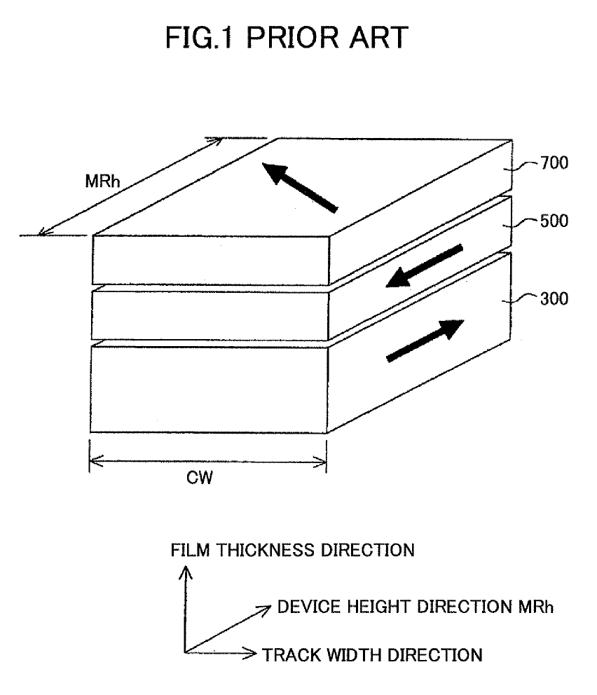

In the laminated ferri structure illustrated in FIG. 1, the reference layer 500 is arranged closer to the free layer 700 than the pin layer 300 is to the free layer 700. Hence, it is desirable to avoid the leak magnetic field from the reference layer 500 acting more strongly on the free layer 700 than the leak magnetic field from the pinned layer 300. But then, the magnetization direction of the free layer 700 tilts in the device height direction MRh from the core width direction CW due to the effects of a combined leak magnetic field which is made up of the leak magnetic field from the reference layer 500 and the leak magnetic field from the pinned layer 300. When the magnetization direction of the free layer 700 tilts from the core width direction CW, the reproduced output waveform from the reproducing head becomes asymmetrical.

The present inventor studied reducing the effects of the reference layer 500 and the pinned layer 300 on the free layer 700. The present inventor regarded that, if the effects from the reference layer 500 were reduced and the effects from the pinned layer 300 were increased, the effects on the free layer 700 as a whole would be reduced. The magnetic poles of the reference layer 500 and the pinned layer 300 are formed at both ends along the device height direction MRh. If the magnetic poles were located at the same height or level, the effects on the free layer 700 would be stronger from the reference layer 500 which is closer to the free layer 700 than the pinned layer 300 is to the free layer 700. Hence, the present inventor studied the changes that occur when the length in the device height direction MRh is changed to change the height of the magnetic poles.

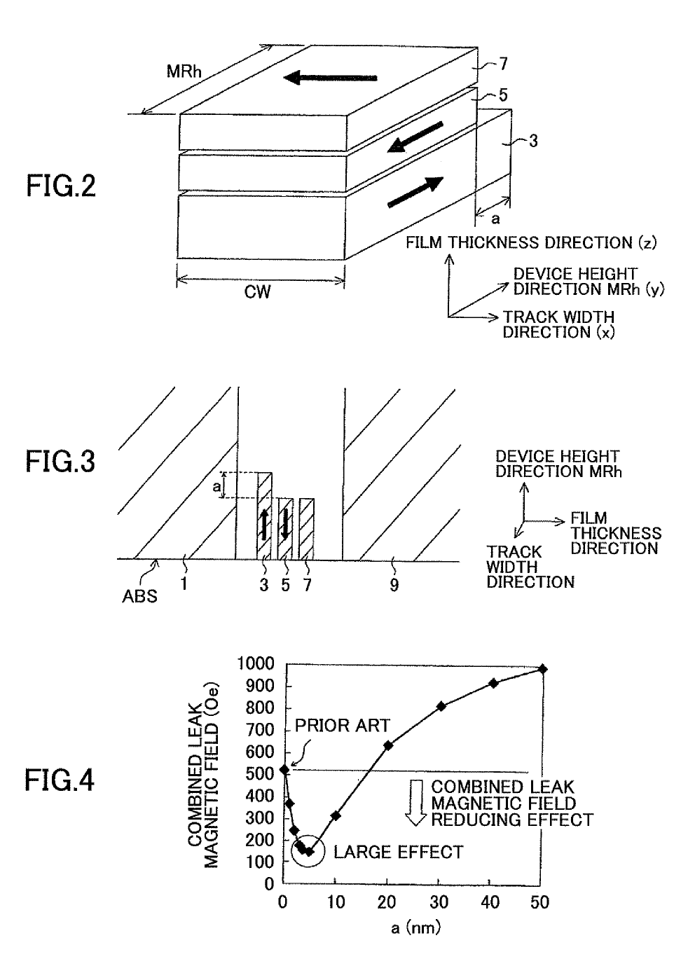

FIG. 2 is a perspective view generally illustrating a laminated ferri structure in an embodiment of the present invention. The laminated ferri structure illustrated in FIG. 2 includes a pinned layer 3, a reference layer 5 and a free layer 7 which are successively stacked. The magnetization direction of the pinned layer 3 is pinned in a direction taken along a device height MRh (hereinafter simply referred to as a device height direction MRh). The magnetization direction of the reference layer 5 is antiparallel with respect to that of the pinned layer 3. The magnetization direction of the free layer 7 is set in a direction taken along a core width CW (hereinafter simply referred to as a core width direction CW) in a state where no external field is applied, and freely rotatable by the applied external field.

Unlike the laminated ferri structure illustrated in FIG. 1, the free layer 7 and the reference layer 5 are patterned to be shorter in length than the pinned layer 3 along the device height direction MRh. In other words, the upper magnetic pole of the pinned layer 3 projects above the magnetic pole of the reference layer 5. The parallel layers 3, 5 and 7 are patterned in common to the same width along the core width direction CW, and are aligned with the same width. The core width direction CW corresponds to a direction taken along a track width (hereinafter referred to as a track width direction) on the magnetic recording medium.

FIG. 3 is a cross sectional view illustrating the laminated ferri structure of FIG. 2 sandwiched between a pair of shield layers located on both sides along a direction taken along the film thickness (hereinafter referred to as a film thickness direction). As illustrated in FIG. 3, the device height direction MRh (y-direction), the film thickness direction (z-direction) and the core width direction (or track width direction, x-direction) respectively form an orthogonal coordinate system.

The pinned layer 3, the reference layer 5 and the free layer 7 are stacked above a shield layer 1, and a shield layer 9 is formed above the free layer 7. The term “above” means “towards the right” in the film thickness direction in FIG. 3. A lower surface of the stacked structure illustrated in FIG. 3 is polished to a single plane, to thereby form an air bearing surface ABS. In the device height direction MRh, the height of the pinned layer 3 is set “a” nm higher than the height of the reference layer 5 and the free layer 7.

FIG. 4 is a graph illustrating simulation results of the combined leak magnetic field which is made up of the leak magnetic field from the reference layer 5 and the leak magnetic field from the pinned layer 3, for a case where the pinned layer 3 is 1.6 nm thick, the reference layer 5 is 1.8 nm thick, a gap between the pinned layer 3 and the reference layer 5 is 0.9 nm, a gap between the reference layer 5 and the free layer 7 is 1.0 nm, and the projecting amount “a” of the pinned layer 3 projecting in the device height direction MRh is changed. In FIG. 4, the ordinate indicates the combined leak magnetic field (Oe) which is made up of the leak magnetic fields from the reference layer 5 and the pinned layer 3 and is applied to the end portion of the free layer 7, and the abscissa indicates the projecting amount “a” (nm). As illustrated in FIG. 4, the pinned layer 3 has the magnetization in the upward direction, and the reference layer 5 has the magnetization in the downward direction. The magnetic fields in the device height direction MRh applied from the pinned layer 3 and the reference layer 5 on the free layer 7 were computed. It is assumed for the sake of convenience that the magnetic field takes a positive value in a direction perpendicular to and upward from the paper surface in FIG. 3. When the projecting amount “a” was increased from 0, the combined leak magnetic field decreased from 500 Oe, and assumed a minimum value of approximately 140 Oe when the projecting amount “a” was approximately 4 nm to approximately 4 nm. Thereafter, as the projecting amount “a” increased, the combined leak magnetic field increased and became approximately 500 Oe when the projecting amount “a” was approximately 16 nm. In other words, the combined leak magnetic field was approximately the same when the projecting amount “a” is 0 and when the projecting amount “a” was approximately 16 nm. As the projecting amount “a” was further increased from approximately 16 nm, the combined leak magnetic field further increased.

It may be regarded that the phenomenon described above occurs, because the pinned layer 3 directly opposes the free layer 7 and the effects of the pinned layer 3 on the free layer 7 become stronger when the pinned layer 3 projects above the reference layer 5, but if the projecting amount “a” of the pinned layer 3 is too large, the magnetic pole formed by the end portion of the pinned layer 3 separates from the upper end of the free layer 7 and the effects of the pinned layer 3 on the free layer 7 become weaker. Hence, it was confirmed that the projecting amount “a” of the pinned layer 3 is preferably 1 nm to 15 nm.

Next, a description will be given of embodiments of the present invention based on the above results. First, a general description will be given of the structure of a hard disk magnetic recoding apparatus.

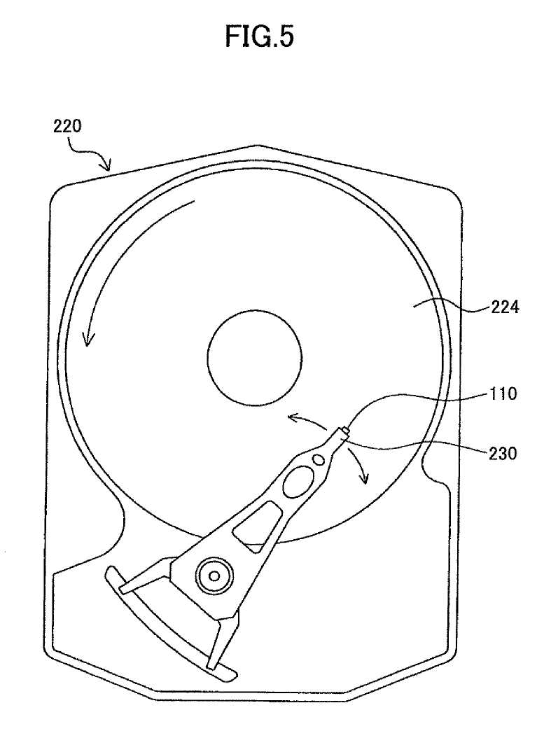

FIG. 5 is a plan view generally illustrating the structure of the hard disk magnetic recoding apparatus. A hard disk magnetic storage apparatus 220 illustrated in FIG. 5 includes an arm 230 which is provided with a write and read head 110. When a hard disk 224 rotates, the write and read head 110 continuously writes information on or continuously reads information from a track on the hard disk 224. The track is selected by moving the arm 230 in a radial direction of the hard disk 224.

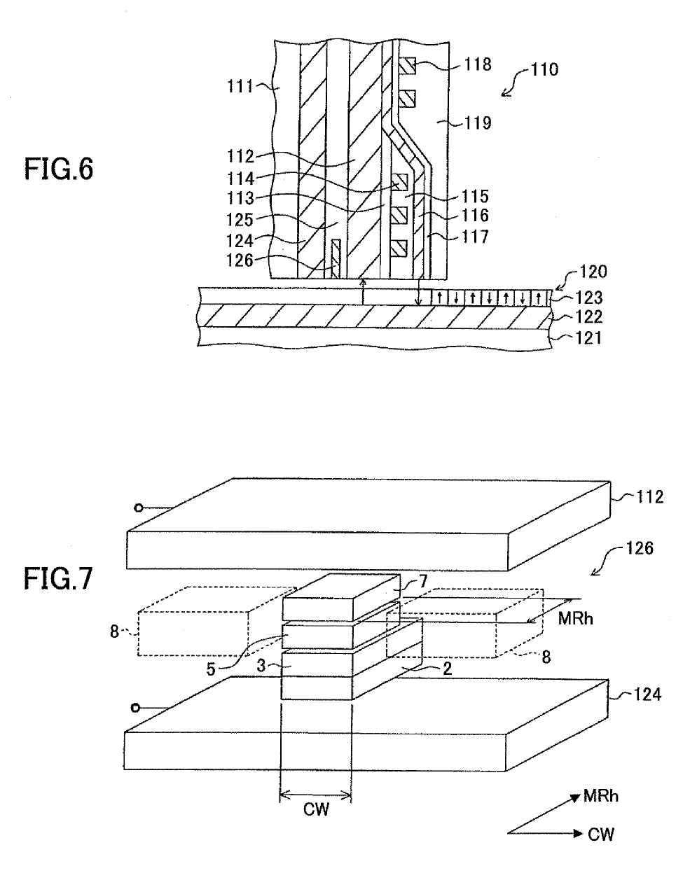

FIG. 6 is a cross sectional view generally illustrating the structure of the write and read head 110. As illustrated in FIG. 6, a lower magnetic shield layer 124 is formed on a nonmagnetic substrate 111. An insulator layer 125, which is embedded with a spin valve magnetic read device 126 having the laminated ferri structure, is formed on the lower magnetic shield layer 124. An auxiliary magnetic pole 112, which also functions as an upper magnetic shield layer, is formed on the insulator layer 125. An insulator layer 113 is formed on the auxiliary magnetic pole 112. A partial coil 114 is formed on the insulator layer 113 by depositing a conductor layer and patterning this conductor layer, and this partial coil 114 is embedded in an insulator 115. A main magnetic pole 116 is formed on the insulator layer 115 by depositing a magnetic layer having a high saturation magnetic flux density and patterning this magnetic layer. An insulator layer 117 is formed so that the main magnetic pole 116 is embedded therein. A partial coil 118, corresponding to the remaining portion of the coil, is formed so as to be connected to the partial coil 114. The partial coil 118 is embedded in an insulator protection layer 119, and this insulator protection layer 119 forms a flat surface. Lower surfaces of the nonmagnetic substrate 111 and the stacked structure provided on the nonmagnetic substrate 111 form an air bearing surface. The stacked structure is arranged perpendicular to the air bearing surface.

The hard disk 120 is arranged so that the rotating surface of the hard disk 120 confronts the air bearing surface of the read and write head 110 having the above described structure. The hard disk 120 includes a substrate 121, a soft magnetic underlayer 122 and a recording layer 123 which are successively stacked on the substrate 121. The writing of information to the recording layer 123 is performed by the magnetic field generated from the main magnetic pole 116, that is, by the inductive type magnetic head. The auxiliary magnetic pole 112 provides an auxiliary magnetic path and forms a magnetic closed circuit. The reading of information from the recording layer 123 is performed by the spin valve magnetic read device 126 which has the laminated ferri structure and whose magneto-resistance changes depending on the magnetic field of the recording layer 123.

A description will be given of an example which employs the Current Perpendicular to the Plane (CPP) structure, where the shield layers 112 and 124 are used as electrodes and the current is made to flow perpendicularly to the layers of the laminated ferri structure. However, the embodiments of the present invention are of course not limited to the CPP structure.

FIG. 7 is a perspective view illustrating the laminated ferri structure of the spin valve magnetic read device 126 which is sandwiched between the shield layers 124 and 112. The pinned layer 3 which is made of a ferromagnetic material and is stacked on an antiferromagnetic layer 2 forms a pinned magnetization that is pinned in the device height direction MRh. The reference layer 5 which is antiferromagnetically coupled to the pinned layer 3 forms a pinned magnetization antiparallel to that of the pinned layer 3. The free layer 7, which is arranged above the reference layer 5, can freely rotate the magnetization direction thereof depending on the external field.

In FIG. 7, the front surface is the air bearing surface ABS. T the direction taken along the depth is the device height direction MRh which is perpendicular to the air bearing surface ABS, and the horizontal direction is the core width direction CW which is perpendicular to the device height direction MRh. The lengths of the pinned layer 3 and the antiferromagnetic layer 2 in the device height direction MRh is set longer than the lengths of the free layer 7 and the reference layer 5 in the device height direction MRh. In other words, the reference 5, which is located closer to the free layer 7 than the pinned layer 3 is to the free layer 7, is shorter than the pinned layer 3 along the device height direction MRh in order to reduce the effects of the reference layer 5 on the free layer 7. By appropriately selecting the projecting amount “a” of the pined layer 3, it is possible to reduce the combined leak magnetic field as illustrated in FIG. 4. A magnetic domain control layer 8 is arranged on both right and left sides of the free layer 7, and controls the magnetization of the free layer 7 in the core width direction CW.

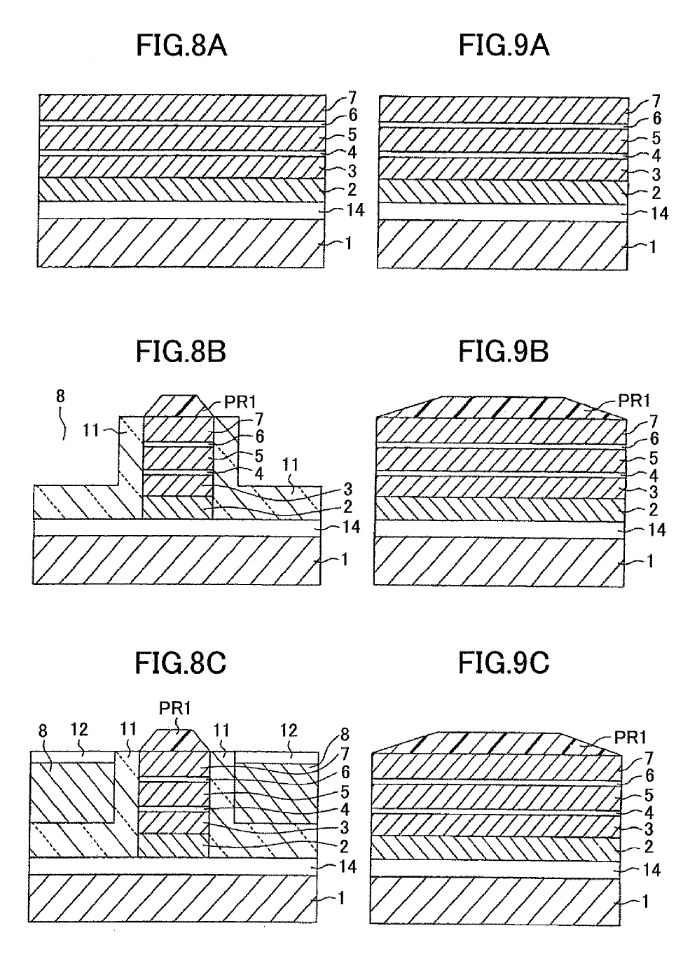

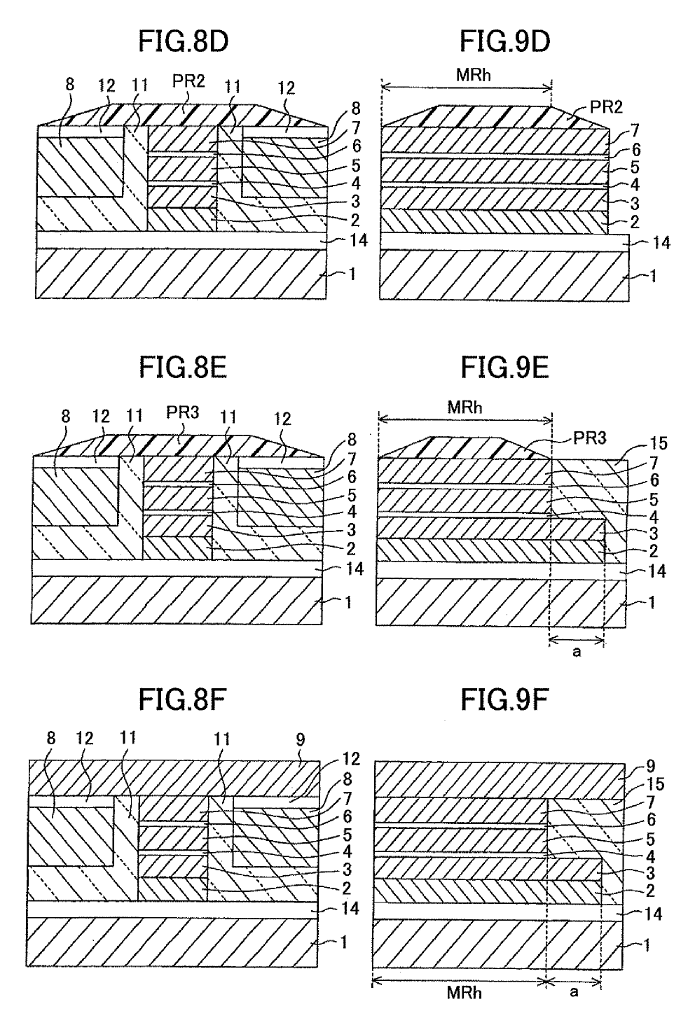

FIGS. 8A through 8F and FIGS. 9A through 9F are cross sectional views illustrating the laminated ferri structure at typical fabricating stages in a method of fabricating the laminated ferri structure of FIG. 7. FIGS. 8A through 8F illustrate the cross sections taken along the code width direction CW, and FIGS. 9A through 9F illustrate the cross sections taken along the device height direction MRh at the fabricating stages corresponding to FIGS. 8A through 8F.

As illustrated in FIGS. 8A and 9A, a soft magnetic material, such as NiFe, is formed on a nonmagnetic substrate (not shown), as the shield layer 1. The shield layer 1 may be used in common as an electrode. An underlayer 14 made of Ta, for example, is formed on the shield layer 1, and a laminated ferri type spin valve device is formed on the underlayer 14. For example, the laminated ferri type spin valve device is formed by successively stacking the antiferromagnetic layer 2 to a thickness of approximately 7 nm, the pinned layer 3 to a thickness of approximately 1.6 nm, an intermediate layer 4 to a thickness of approximately 0.9 nm, the reference layer 5 to a thickness of approximately 1.8 nm, a nonmagnetic intermediate layer 6 to a thickness of approximately 1.0 nm, and the free layer 7 to a thickness of approximately 4 nm. The intermediate layer 4 is provided to antiferromagnetically couple the pinned layer 3 and the reference layer 5, that is, cause antiparallel magnetizations between the pinned layer 3 and the reference layer 5.

The intermediate layer 6 is provided to magnetically isolate the free layer 7 and the reference layer 5. The intermediate layer 6 may be made of an insulator, such as Al₂O₃ and MgO, to cause a tunneling current to flow in the film thickness direction. On the other hand, the intermediate layer 6 may be made of a conductor, such as Cu, to cause a conduction current to flow in the film thickness direction. The laminated ferri structure becomes the tunneling junction type GMR device when the insulator is used for the intermediate layer 6. The laminated ferri structure becomes the CPP type GMR device when the conductor is used for the intermediate layer 6.

For example, the antiferromagnetic layer 2 may be made of IrMn, PdPtMn or the like. Each of the pinned layer 3, the reference layer 5 and the free layer 7 may be made of ferromagnetic materials such as NiFe, CoFeB or the like, and may have a single-layer structure of a multi-layer structure.

As illustrated in FIGS. 8B and 9B, a photoresist pattern PR1 is formed on the free layer 7, and an etching is carried out from the free layer 7 to the antiferromagnetic layer 2 in the core width direction CW by ion milling or the like using the photoresist pattern PR1 as a mask. The etching may be carried out to the underlayer 14. A portion of the antiferromagnetic layer 2 may remain after the etching. Next, the nonmagnetic insulator layer 11 made of Al₂O₃ or the like is formed without removing the photoresist pattern PR1.

As illustrated in FIGS. 8C and 9C, the magnetic domain control layer 8 and a nonmagnetic insulator layer 12 are successively stacked without removing the photoresist layer PR1. The magnetic domain control layer 8 may have a high-coercivity layer made of CoCrPt or the like or, a stacked layer structure including an antiferromagnetic layer made of IrMn, PdPtMn or the like, and a soft magnetic (or ferromagnetic) layer made of NiFe, CoFeB or the like, for example. For example, the high-coercivity layer has a coercivity of approximately 500 Oe or greater. The nonmagnetic insulator layer 12 is made of Al₂O₃ or the like. Thereafter, the photoresist pattern PR1 is removed.

As illustrated in FIGS. 8D and 9D, a photoresist pattern PR2 is formed for use in newly carrying out an etching in the device height direction MRh. The etching is carried out from the free layer 7 to the antiferromagnetic layer 2 by ion milling or the like using the photoresist pattern PR2 as a mask. The etching may be carried out to the underlayer 14, and a portion of the antiferromagnetic layer 2 may remain after the etching. The pinned layer 3 and the antiferromagnetic layer 2 are patterned in the device height direction MRh. Thereafter, the photoresist pattern PR2 is removed.

As illustrated in FIGS. 8E and 9E, a photoresist pattern PR3 is formed for use in etching the free layer 7 and the reference layer 5 in the device height direction MRh. The etching is carried out from the free layer 7 to the reference layer 5 by ion milling or the like using the photoresist pattern PR3 as a mask. The etching may be carried out to the intermediate layer 4. A nonmagnetic insulator layer 15 is formed without removing the photoresist layer PR3. Thereafter, the photoresist pattern PR3 is removed.

As illustrated in FIGS. 8F and 9F, the shield layer 9 is formed. The shield layer 9 may be used in common as an electrode. For example, the shield layer 9 may be made of NiFe or the like.

In the method of fabricating the laminated ferri structure described above, the shield layers 1 and 9 may be formed by plating, deposition, sputtering or the like. The antiferromagnetic layer 2, the pinned layer, the intermediate layer 4 made of Ru or the like, the reference layer 5, the intermediate layer 6, the free layer 7, the magnetic domain control layer 8, the insulator layers 11 and 12, and the nonmagnetic insulator layer 15 may be formed by sputtering or the like.

In this embodiment described above, the pinned layer 3 projects in the device height direction MRh from the free layer 7 and the reference layer 5. By controlling the projecting amount “a” of the pinned layer 3, it is possible to obtain the effect of reducing the combined leak magnetic field as described above in conjunction with FIG. 4. It was confirmed that the effect of reducing the combined leak magnetic field is obtainable when the projecting amount “a” is set in a range of 1 nm to 15 nm.

The present inventor also studied a structure in which a portion of the pinned layer 3 closer to the reference layer 5 is made to the same height as the reference layer 5, while a portion of the pinned layer 3 further away from the reference layer 5 is made to project from the reference layer 5 in the device height direction MRh.

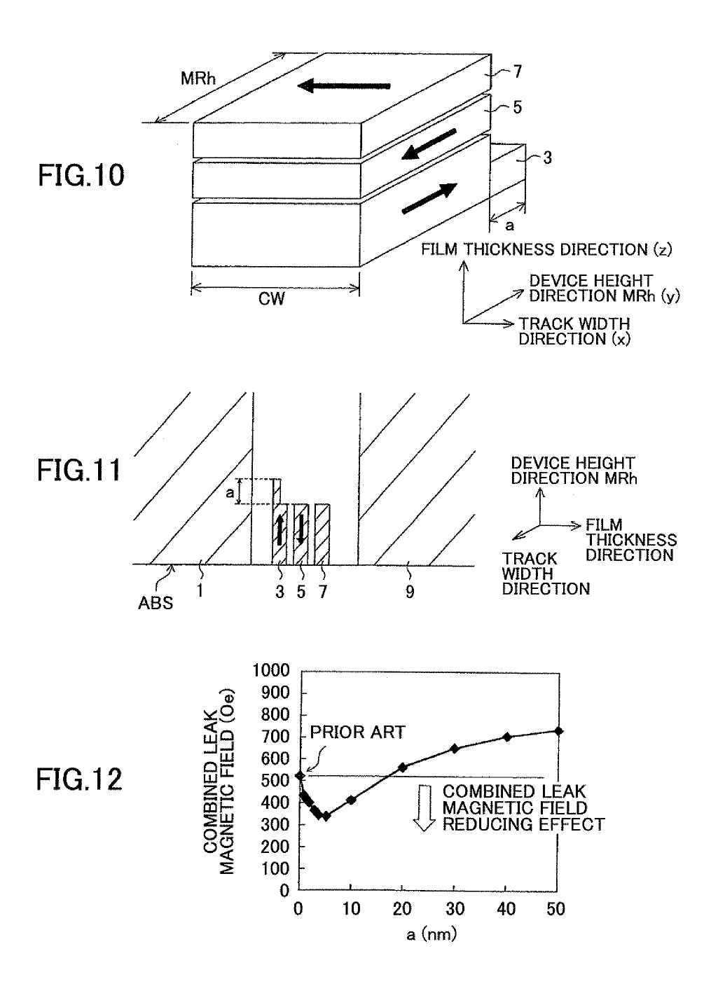

FIG. 10 is a perspective view generally illustrating a laminated ferri structure in a first modification of the embodiment of the present invention. In FIG. 10, those parts that are the same as those corresponding parts in FIG. 2 are designated by the reference numerals.

The laminated ferri structure illustrated in FIG. 10 includes a pinned layer 3, a reference layer 5 and a free layer 7 which are successively stacked. The magnetization direction of the pinned layer 3 is pinned in a direction taken along the device height direction MRh. The magnetization direction of the reference layer 5 is antiparallel with respect to that of the pinned layer 3. The magnetization direction of the free layer 7 is set in a direction taken along the core width direction CW in a state where no external field is applied, and can freely be rotated by the applied external field.

A first portion of the pinned layer 3 closer to the reference layer 5 is patterned to the same height as the reference layer 5 and the free layer 7. On the other hand, a second portion of the pinned layer 3, further away from the reference layer 5 than the first portion, is patterned to project from the reference layer 5 and the free layer 7 in the device height direction MRh by the projecting amount “a” (nm). The pinned layer 3, the reference layer 5 and the free layer 7 are patterned in common to the same core width CW in the core width direction CW, that is, in the track width direction.

FIG. 11 is a cross sectional view illustrating the laminated ferri structure of FIG. 10 sandwiched between a pair of shield layers located on both sides along a direction taken along the film thickness direction. In FIG. 11, those parts that are the same as those corresponding parts in FIG. 3 are designated by the same reference numerals. As illustrated in FIG. 11, the first portion of the pinned layer 3 closer to the reference layer 5 is patterned to the same height as the reference layer 5 and the free layer 7. Otherwise, the laminated ferri structure of FIG. 11 is the same as that illustrated in FIG. 3.

FIG. 12 is a graph illustrating simulation results of the combined magnetic field which is made up of the leak magnetic field from the reference layer and the leak magnetic field from the pinned layer. The simulation results of FIG. 12 were obtained under conditions similar to those used to obtain the simulation results of FIG. 4.

In FIG. 12, when the projecting amount “a” was increased from 0, the combined magnetic field decreased from 500 Oe, and assumed a minimum value of approximately 320 Oe when the projecting amount “a” was approximately 3 nm to approximately 4 nm. Thereafter, as the projecting amount “a” increased, the combined magnetic field increased and became approximately 500 Oe when the projecting amount “a” was approximately 16 nm to approximately 17 nm. As the projecting amount “a” was further increased, the combined magnetic field further increased. Because the first portion of the pinned layer 3 closer to the reference layer 5 is patterned to the same height as the reference layer 5 and the free layer 7, while the second portion of the pinned layer 3, further away from the reference layer 5 than the first portion, is patterned to project from the reference layer 5 and the free layer 7 in the device height direction MRh by the projecting amount “a” (nm), the effect of reducing the combined leak magnetic field is smaller than that of FIG. 4 for the same projecting amount “a”. It was confirmed that the projecting amount “a” of the second portion of the pinned layer 3 is preferably 1 nm to 15 nm, similarly to the case of FIG. 4.

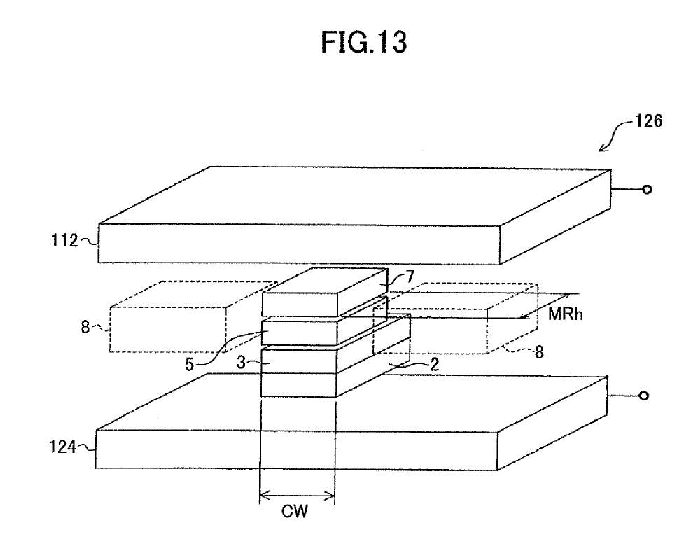

FIG. 13 is a perspective view illustrating the laminated ferri structure of the spin valve magnetic read device 126 which is sandwiched between the shield layers 124 and 112. In FIG. 13, those parts that are the same as those corresponding parts in FIG. 7 are designated by the same reference numerals. The first portion of the pinned layer 3 closer to the reference layer 5 is patterned to the same height as the reference layer 5 and the free layer 7. Otherwise, the laminated ferri structure of FIG. 11 is the same as that illustrated in FIG. 7.

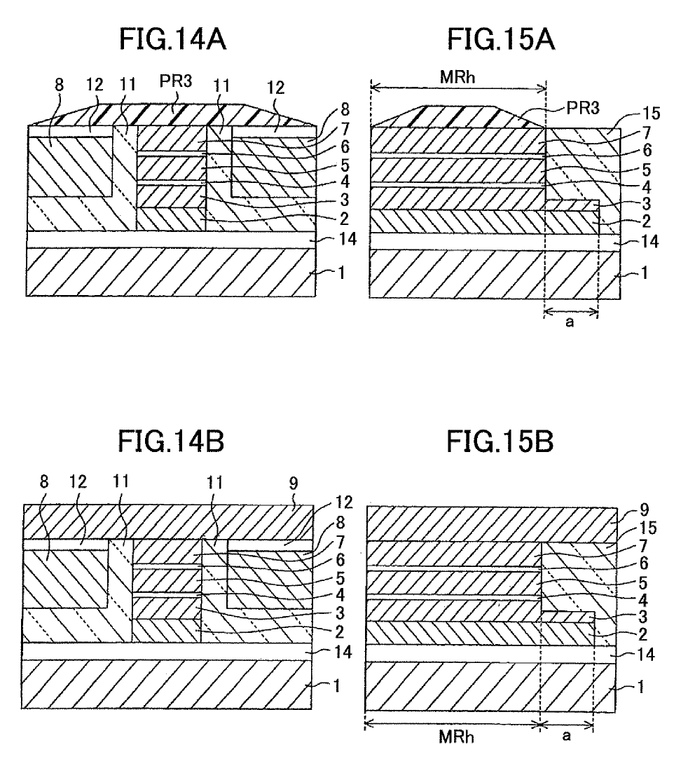

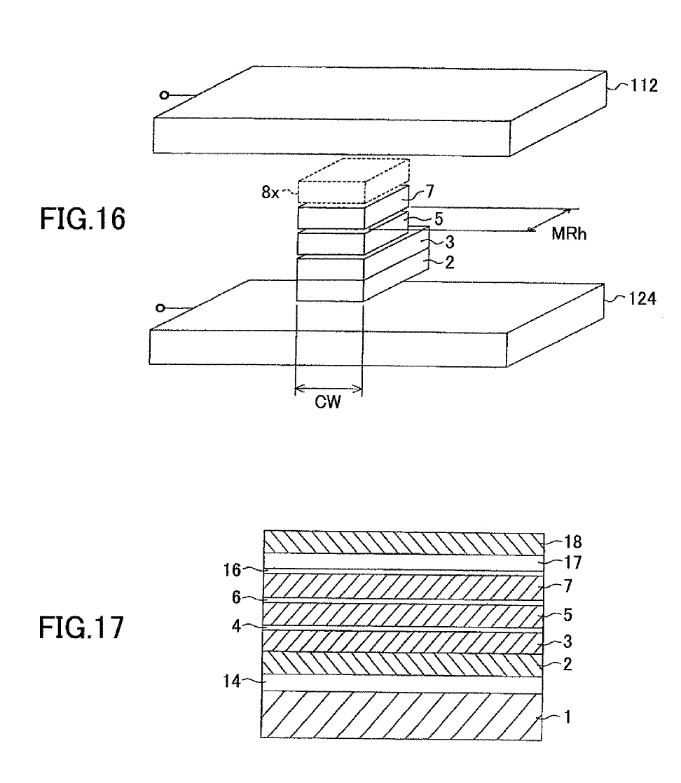

FIGS. 14A and 14B and FIGS. 15A and 15B are cross sectional views illustrating the laminated ferri structure at typical fabricating stages in a method of fabricating the laminated ferri structure of FIG. 13. FIGS. 15A and 15B illustrate the cross sections taken along the code width direction CW, and FIGS. 16A and 16B illustrate the cross sections taken along the device height direction MRh at the fabricating stages corresponding to FIGS. 15A and 15B.

As may be seen from FIGS. 14A, 14B, 15A and 15B, a portion of the pinned layer 3 is also etched when etching the free layer 7 and the reference layer 5, so that the first portion of the pinned layer 3 closer to the reference layer 5 is patterned to the same height as the reference layer 5 and the free layer 7, while the second portion of the pinned layer 3, further away from the reference layer 5 than the first portion, is patterned to project from the reference layer 5 and the free layer 7 in the device height direction MRh by the projecting amount “a”. Otherwise, the method is basically the same as that described above in conjunction with FIGS. 8A through 8F and FIGS. 9A through 9F.

In this first modification, the magnetic domain control layer 8, which is arranged on both sides of the free layer 7, has a high-coercivity layer or, a stacked layer structure including an antiferromagnetic layer and a ferromagnetic layer. However, the magnetic domain control layer 8 may be stacked on the free layer 7. For example, the high-coercivity layer has a coercivity of approximately 500 Oe or greater.

FIG. 16 is a perspective view illustrating the laminated ferri structure of a spin valve magnetic read device in a second modification of the embodiment of the present invention, and FIG. 17 is a cross sectional view illustrating the laminated ferri structure of FIG. 16 in more detail. In FIGS. 16 and 17, those parts that are the same as those corresponding parts in FIG. 7 are designated by the same reference numerals.

Unlike the laminated ferri structure of FIG. 7, the laminated ferri structure of FIG. 16 includes a magnetic domain control layer 8x which is stacked on the free layer 7, in place of the magnetic domain control layer 8 provided on both sides of the free layer 7 in FIG. 7.

As illustrated in FIG. 17, the underlayer 14 made of Ta, for example, is formed on the shield layer 1, and a laminated ferri type spin valve device is formed on the underlayer 14. For example, the laminated ferri type spin valve device is formed by successively stacking the antiferromagnetic layer 2, the pinned layer 3, the intermediate layer made of Ru or the like, the reference layer 5, the nonmagnetic intermediate layer 6, and the free layer 7. In addition, an intermediate layer 16 made of Cu or the like, a ferromagnetic layer 17 made of CoFeB or the like, and an antiferromagnetic layer 18 made of IrMn or the like are successively stacked on the free layer 7. The ferromagnetic layer 17 and the antiferromagnetic layer 18 form the magnetic domain control layer 8x. When magnetizing the antiferromagnetic layers 2 and 18, the antiferromagnetic layer 2 is magnetized in the device height direction MRh, while the antiferromagnetic layer 18 is magnetized in the core width direction CW. Because the two antiferromagnetic layers 2 and 18 are magnetized in mutually different directions, it is desirable that the antiferromagnetic layers 2 and 18 have mutually different blocking (or demagnetizing) temperatures.

Of course, the layer materials, the layer structure, the layer thickness and the like of the described embodiment and modifications are examples, and other layer materials, layer structures and layer thicknesses may be employed. In addition, portions of the laminated ferri structure, other than the projecting structure of the pinned layer with respect to the reference layer, may employ other known structures.

In the embodiment and modifications described above, at least a portion of the pinned layer projects from the reference layer in the device height direction, in order to increase the effective area or, the effective volume of the pinned layer that contributes to the reduction of the combined leak magnetic field which is made up of the leak magnetic field from the reference layer and the leak magnetic field from the pinned layer. However, at least a portion of the pinned layer may project from the reference layer in the core width direction, in order to similarly increase the effective area or, the effective volume of the pinned layer that contributes to the reduction of the combined leak magnetic field. In other words, the pinned layer may have various structures which enable the area of the pinned layer to be larger than the area of the reference layer, in order to reduce the effects of the reference layer and the pinned layer on the free layer.

Further, the present invention is not limited to these embodiments, but various variations and modifications may be made without departing from the scope of the present invention.

1. A magnetic head comprising:
a free layer made of a ferromagnetic material and having a magnetization direction which is rotatable depending on an external field;
a reference layer made of a ferromagnetic material and arranged parallel to the free layer;
a pinned layer made of a ferromagnetic material and arranged parallel to the reference layer; and
an antiferromagnetic layer made of an antiferromagnetic material and arranged parallel to the pinned layer,
wherein the pinned layer has a magnetization direction which is pinned in a first direction by the antiferromagnetic layer, and a magnetization direction of the reference layer is antiparallel with respect to that of the pinned layer, and
the pinned layer forms a step with respect to the reference layer so that the pinned layer has an area larger than that of the reference layer.

2. The magnetic head as claimed in claim 1, further comprising:
a substrate having an air bearing surface,
wherein each of the free layer, the reference layer and the pinned layer are arranged perpendicularly to the air bearing surface, and the first direction is perpendicular to the air bearing surface.

3. The magnetic head as claimed in claim 2, further comprising:
a first intermediate layer interposed between the free layer and the reference layer and configured to magnetically isolate the free layer and the reference layer; and
a second intermediate layer interposed between the reference layer and the pinned layer and configured to antiferromagnetically couple the pinned layer and the reference layer.

4. The magnetic head as claimed in claim 2, further comprising:
a magnetic domain control layer disposed on both sides of a laminated ferri structure which is formed by the free layer, the reference layer and the pinned layer;
wherein the magnetic domain control layer has a high-coercivity layer or a stacked structure including an antiferromagnetic layer and a ferromagnetic layer.

5. The magnetic head as claimed in claim 1, further comprising:
a magnetic domain control layer disposed on the free layer,
wherein the magnetic domain control layer has a high-coercivity layer or a stacked structure including an antiferromagnetic layer and a ferromagnetic layer.

6. The magnetic head as claimed in claim 2, wherein:
the pinned layer and the reference layer have identical widths along a second direction which is perpendicular to the first direction and is parallel to the pinned layer and the reference layer; and
at least a portion of the pinned layer, on an opposite from the reference layer, projects from the reference layer by a predetermined distance along the first direction.

7. The magnetic head as claimed in claim 6, wherein the predetermined distance is 1 nm to 15 nm.

8. The magnetic head as claimed in claim 2, wherein:
the pinned layer, the reference layer and the free layer have identical widths along a second direction which is perpendicular to the first direction and is parallel to the pinned layer and the reference layer; and
the pinned layer projects from the reference layer and the free layer by a predetermined distance.

9. The magnetic head as claimed in claim 8, wherein the predetermined distance is 1 nm to 15 nm.

10. The magnetic head as claimed in claim 1, further comprising:
a pair of shield layers sandwiching a laminated ferri structure which is formed by the free layer, the reference layer and the pinned layer; and
an intermediate layer made of a conductor and disposed between the free layer and the reference layer, configured to cause a conduction current to flow in a direction taken along a film thickness of each of the layers forming the laminated ferri structure.

11. The magnetic head as claimed in claim 1, further comprising:
a pair of shield layers sandwiching a laminated ferri structure which is formed by the free layer, the reference layer and the pinned layer; and
an intermediate layer made of an insulator and disposed between the free layer and the reference layer, configured to cause a tunneling current to flow in a direction taken along a film thickness of each of the layers forming the laminated ferri structure.

12. The magnetic head as claimed in claim 1, further comprising:
an inductive type magnetic head.

13. A magnetic storage apparatus comprising:
a magnetic recording medium having a rotating surface; and
a magnetic head arranged to confront the rotating surface of the magnetic recording medium,
said magnetic head comprising:
a free layer made of a ferromagnetic material and having a magnetization direction which is rotatable depending on an external field;
a reference layer made of a ferromagnetic material and arranged parallel to the free layer;
a pinned layer made of a ferromagnetic material and arranged parallel to the reference layer; and
an antiferromagnetic layer made of an antiferromagenetic material and arranged parallel to the pinned layer,
wherein the pinned layer has a magnetization direction which is pinned in a first direction by the antiferromagnetic layer, and a magnetization direction of the reference layer is antiparallel with respect to that of the pinned layer, and
the pinned layer forms a step with respect to the reference layer so that the pinned layer has an area larger than that of the reference layer.

14. The magnetic storage apparatus as claimed in claim 13, wherein the magnetic head further comprises an inductive type magnetic head.

15. The magnetic head as claimed in claim 1, wherein a thickness of a portion of the pinned layer at said step, taken along a direction in which the antiferromagnetic layer, the pinned layer, the reference layer and the free layer are stacked, is smaller than that of a remaining portion of the pinned layer.

16. The magnetic head as claimed in claim 1, wherein the pinned layer is provided on the antiferromagnetic layer.

17. The magnetic storage apparatus as claimed in claim 13, wherein a thickness of a portion of the pinned layer at said step, taken along a direction in which the antiferromagnetic layer, the pinned layer, the reference layer and the free layer are stacked, is smaller than that of a remaining portion of the pinned layer.

18. The magnetic storage apparatus as claimed in claim 13, wherein the pinned layer is provided on the antiferromagnetic layer.
